(19) United States
(12) Patent Application Publication
(10) Pub. No.: US 2025/0084202 A1
(43) Pub. Date: Mar. 13, 2025

(54) SELF-HEALING RESIN COMPOSITION AND SELF-HEALING MEMBRANE STRUCTURE

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Ren-Yu Liao, New Taipei City (TW)

(21) Appl. No.: 18/510,665

(22) Filed: Nov. 16, 2023

(30) Foreign Application Priority Data
Sep. 12, 2023 (TW) 112134574

(51) Int. Cl. C08G 18/73; C08G 18/42; C09J 7/29; C09J 7/38

(52) U.S. Cl. CPC C08G 18/73; C08G 18/4238; C09J 7/29; C09J 7/38; C09J 2427/006; C09J 2475/006

(57) ABSTRACT

A self-healing resin composition and a self-healing membrane structure are provided. The self-healing resin composition includes 20 phr to 50 phr of a self-healing resin, 1 phr to 10 phr of a hardener, 0.1 phr to 3 phr of a matting agent, and 40 phr to 80 phr of a solvent. The self-healing resin is polymerized from a polyester polyol, a diisocyanate monomer, and a bisphenol monomer. A molar ratio of a hydroxyl group to an isocyanate group in monomers to polymerize the self-healing resin ranges from 1.33 to 2.0. A number average molecular weight of the self-healing resin ranges from 30,000 g/mol to 200,000 g/mol.

### CROSS-REFERENCE TO RELATED PATENT APPLICATION

This application claims the benefit of priority to Taiwan Patent Application No. 112134574, filed on Sep. 12, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a self-healing resin composition and a self-healing membrane structure, and more particularly to a self-healing resin composition and a self-healing membrane structure that have a high transparency and a haze with pre-adjustivity.

### BACKGROUND OF THE DISCLOSURE

Many substrates on the market, such as car casings, mobile phone cases, or laptop casings, have low scratch resistance, and appearances thereof will be negatively affected due to easy formation of permanent scratches during use. As such, a protective layer is usually disposed on the substrate to maintain the integrity of its appearance and extend its service life.

With the advancement of technology and the discovery of self-healing materials, the self-healing material is being applied to the substrate as a protective layer. In this way, if scratches are formed on the substrate due to an external force, restoration of the appearance of the substrate can be achieved by heating. However, existing self-healing materials cannot simultaneously have a high transparency and be pre-adjusted to have a matte or a glossy appearance.

In the conventional technology, in order to have the matte appearance, the self-healing material can be subjected to a matte process, or scattering particles can be added into the self-healing material. However, the matte process may alter a self-healing ability of the self-healing material, and the scattering particles may fall off after being added into the self-healing material. Therefore, how to improve a self-healing composition by adjusting the contents and design thereof has become one of the important issues to be addressed in this industry.

### SUMMARY OF THE DISCLOSURE

In response to the above-referenced technical inadequacies, the present disclosure provides a self-healing resin composition and a self-healing membrane structure.

In order to solve the above-mentioned problems, one of the technical aspects adopted by the present disclosure is to provide a self-healing resin composition. The self-healing resin composition includes: 20 phr to 50 phr of a self-healing resin, 1 phr to 10 phr of a hardener, 0.1 phr to 3 phr of a matting agent, and 40 phr to 80 phr of a solvent. The self-healing resin is polymerized from a polyester polyol, a diisocyanate monomer, and a bisphenol monomer. A molar ratio of a hydroxyl group to an isocyanate group in monomers to polymerize the self-healing resin ranges from 1.33 to 2.0. A number average molecular weight of the self-healing resin ranges from 30,000 g/mol to 200,000 g/mol.

In one of the possible or preferred embodiments, based on a total weight of the monomers to polymerize the self-healing resin being 100 wt %, an amount of the polyester polyol ranges from 75 wt % 90 wt %, an amount of the diisocyanate monomer ranges from 3 wt % 10 wt %, and an amount of the bisphenol monomer ranges from 5 wt % 15 wt %.

In one of the possible or preferred embodiments, a number average molecular weight of the polyester polyol ranges from 3,000 g/mol to 5,000 g/mol.

In one of the possible or preferred embodiments, the polyester polyol is polymerized from adipic acid, 1,4-butanediol, 1,6-hexanediol, and 2-methyl-1,3-propanediol.

In one of the possible or preferred embodiments, a molar ratio of 1,4-butanediol to 1,6-hexanediol ranges from 1:0.5 to 1:2, and a molar ratio of 1,4-butanediol to 2-methyl-1,3-propanediol ranges from 1:0.33 to 1:3.

In one of the possible or preferred embodiments, the diisocyanate monomer is selected from the group consisting of: hexamethylene diisocyanate, 4,4′-diisocyanato dicyclohexylmethane, isophorone diisocyanate, isophorone diisocyanate, methylene diphenyl diisocyanate, and hexamethylene diisocyanate trimer.

In one of the possible or preferred embodiments, the bisphenol monomer is selected from the group consisting of: bisphenol A, bis(4-hydroxyphenyl)cyclohexane, 1,1′-bis(4-hydroxyphenyl)-3,3,5-trimethylcyclohexane, bisphenoxyethanolfluorene, and dimethyl-bisphenol A.

In order to solve the above-mentioned problems, another one of the technical aspects adopted by the present disclosure is to provide a self-healing membrane structure. The self-healing membrane structure includes a substrate layer, a self-healing membrane layer, an adhesive layer, and a release layer. The substrate layer has a first surface and a second surface. The self-healing membrane layer is disposed on the first surface. The self-healing membrane layer is formed from the above-mentioned self-healing resin composition. The adhesive layer is disposed on the second surface. The release layer is disposed on the adhesive layer such that the adhesive layer is disposed between the substrate layer and the release layer.

In one of the possible or preferred embodiments, the substrate layer is a polyurethane substrate or a polyvinyl chloride substrate.

In one of the possible or preferred embodiments, a thickness of the self-healing membrane layer ranges from 5 μm to 50 μm.

Therefore, in the self-healing resin composition and the self-healing membrane structure provided by the present disclosure, by virtue of “the self-healing resin being polymerized from a polyester polyol, a diisocyanate monomer, and a bisphenol monomer,” “a molar ratio of a hydroxyl group to an isocyanate group in monomers to polymerize the self-healing resin ranging from 1.33 to 2.0,” and “a number average molecular weight of the self-healing resin ranging from 30,000 g/mol to 200,000 g/mol,” the self-healing membrane layer formed from the self-healing resin composition having a self-healing ability when being temporarily heated or at a room temperature.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of a self-healing membrane structure according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a self-healing resin composition. The self-healing resin composition has a low chemical bonding energy, such that the self-healing resin composition has a self-healing ability at a low temperature. The self-healing resin composition has a high transparency. In addition, even when scattering particles are added, the self-healing resin composition still has the self-healing ability. The self-healing resin composition can be coated on a substrate to form a self-healing resin material, so as to achieve a protective effect.

For the convenience of use, the self-healing resin composition can also be used to manufacture a self-healing membrane structure. The self-healing membrane structure can be disposed on any to-be-protected surface. The self-healing membrane structure has the self-healing ability, and can be restored to its original appearance. When the self-healing membrane structure has scratches or is deformed due to an external force, through appropriate heating, the scratches or the deformation can be repaired by thermal expansion (physical remediation) or by contact and reconnection of cleaved bonds (chemical remediation).

In the present disclosure, the self-healing resin composition and the self-healing membrane structure can be heated at a temperature ranging from 80° C. to 130° C. for a short period of time, or can be placed at a room temperature (e.g., 50° C.) for a long period of time to repair scratches by intermolecular force.

It should be noted that the self-healing resin composition is particularly suitable for being coated on a polyurethane substrate or a polyvinyl chloride substrate, so as to form the self-healing membrane layer (i.e., the self-healing material) for protection purposes.

By adjusting varieties, structures, and contents of monomers to polymerize the self-healing material, the self-healing material of the present disclosure has the self-healing ability. In addition, the self-healing material can be used to form a self-healing membrane layer having a high transparency, and the self-healing membrane layer can selectively have a matte or a glossy surface.

Based on a total weight of the self-healing resin composition being 100 phr, the self-healing resin composition includes 20 phr to 50 phr of a self-healing resin, 1 phr to 10 phr of a hardener, 0.1 phr to 3 phr of a matting agent, and 40 phr to 80 phr of solvent.

In the present disclosure, the self-healing resin is polymerized from a polyester polyol, a diisocyanate monomer, and a bisphenol monomer. Through selection of different monomers, structural designs of the monomers, and adjustment of the contents of the monomers, the self-healing material solidified from the self-healing resin composition can have more hydrogen bonds. When the self-healing material has scratches or is deformed, the self-healing material can be restored by an appropriate heating process.

In an exemplary embodiment, based on a total weight of the monomers to polymerize the self-healing resin being 100 wt %, an amount of the polyester polyol ranges from 75 wt % to 90 wt %, an amount of the diisocyanate monomer ranges from 3 wt % to 10 wt %, and an amount of the bisphenol monomer ranges from 5 wt % to 15 wt %.

Preferably, the amount of the polyester polyol ranges from 85 wt % to 90 wt %, the amount of the diisocyanate monomer ranges from 3 wt % to 5 wt %, and the amount of the bisphenol monomer ranges from 5 wt % to 10 wt %.

In the present disclosure, a number average molecular weight of the self-healing resin ranges from 30,000 g/mol to 200,000 g/mol. When the number average molecular weight of the self-healing resin is outside the above-mentioned range, the self-healing resin does not have the self-healing ability. For example, the number average molecular weight of the self-healing resin can be 40,000 g/mol, 50,000 g/mol, 60,000 g/mol, 70,000 g/mol, 80,000 g/mol, 90,000 g/mol, 100,000 g/mol, 110,000 g/mol, 120,000 g/mol, 130,000 g/mol, 140,000 g/mol, 150,000 g/mol, 160,000 g/mol, 170,000 g/mol, 180,000 g/mol, or 190,000 g/mol.

A molar ratio of a hydroxyl group to an isocyanate group in monomers to polymerize the self-healing resin is also an important parameter. In the present disclosure, the molar ratio of the hydroxyl group to the isocyanate group in the monomers to polymerize the self-healing resin ranges from 1.33 to 2.0. For example, the molar ratio of the hydroxyl group to the isocyanate group in the monomers to polymerize the self-healing resin can be 1.35, 1.40, 1.45, 1.50, 1.55, 1.60, 1.65, 1.70, 1.75, 1.80, 1.85, 1.90, or 1.95.

In other words, an amount of the hydroxyl group is higher than an amount of the isocyanate group in the monomers to polymerize the self-healing resin. When the polyester polyol, the diisocyanate monomer, and the bisphenol monomer are polymerized, the self-healing resin can still have the sufficient hydroxyl group to form the hydrogen bond, so as to achieve a self-healing effect.

The polyester polyol is polymerized from a diol monomer and a diacid monomer. The diol monomer includes 1,4-butanediol, 1,6-hexanediol, and 2-methyl-1,3-propanediol. The diacid monomer includes adipic acid. When 1,4-butanediol, 1,6-hexanediol, 2-methyl-1,3-propanediol, and adipic acid are polymerized to form the polyester polyol, the polyester polyol has an optimal molecular distance and the sufficient hydroxyl group to form the hydrogen bond, so as to achieve the self-healing effect.

In an exemplary embodiment, based on a total weight of the monomers to polymerize the polyester polyol being 100 wt %, an amount of 1,4-butandiol ranges from 30 wt % to 40 wt %, am amount of 1,6-hexanediol ranges from 20 wt % to 30 wt %, an amount of 2-methyl-1,3-propanediol ranges from 15 wt % to 20 wt %, and an amount of adipic acid ranges from 20 wt % to 40 wt %.

Specifically, in the diol monomers to polymerize the polyester polyol, a molar ratio of 1,4-butanediol to 1,6-hexanediol ranges from 1:0.5 to 1:2, and a molar ratio of 1,4-butanediol to 2-methyl-1,3-propanediol ranges from 1:0.33 to 1:3, such that the polyester polyol can have ideal properties.

It should be noted that the diol monomers and the diacid monomers are polymerized to form the polyester polyol, and then the polyester polyol, the diisocyanate monomer, and the bisphenol monomer are polymerized to form the self-healing resin. This process is different from mixing the monomers to polymerize the polyester polyol (i.e., the diol monomers and the diacid monomers) with the diisocyanate monomer and the bisphenol monomer at the same time for polymerization of the self-healing resin. Accordingly, the properties of the polyester polyol can be controlled, and the self-healing resin can achieve an optimal self-healing effect.

The diisocyanate monomer can be selected from the group consisting of: hexamethylene diisocyanate (HDI), 4,4′-diisocyanato dicyclohexylmethane, isophorone diisocyanate (H₁₂MDI), isophorone diisocyanate (IPDI), methylene diphenyl diisocyanate (MDI), and hexamethylene diisocyanate trimer (HDI-trimer).

The bisphenol monomer can be selected from the group consisting of: bisphenol A (BPA), bis(4-hydroxyphenyl)cyclohexane, 1,1′-bis(4-hydroxyphenyl)-3,3,5-trimethylcyclohexane (BP-TMC), bisphenoxyethanolfluorene (BP-EF), and dimethyl-bisphenol A (DMBPA).

According to the descriptions above, the self-healing resin can be represented by a formula (I):

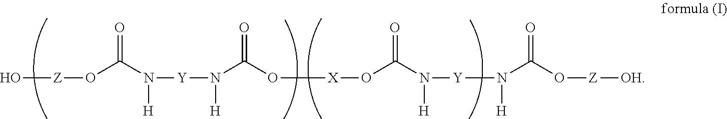

In formula (I), “X” is a structure formed by the polyester polyol after polymerization, “Y” is a structure formed by the diisocyanate monomer after polymerization, and “Z” is a structure formed by the bisphenol monomer after polymerization. A number average molecular weight of the polyester polyol can range from 3,000 g/mol to 5,000 g/mol. However, the present disclosure is not limited thereto.

In an exemplary embodiment, hexamethylene diisocyanate is used as the diisocyanate monomer, and bisphenol A is used as the bisphenol monomer. The self-healing resin polymerized from the polyester polyol, hexamethylene diisocyanate, and bisphenol A is represented by a formula (II):

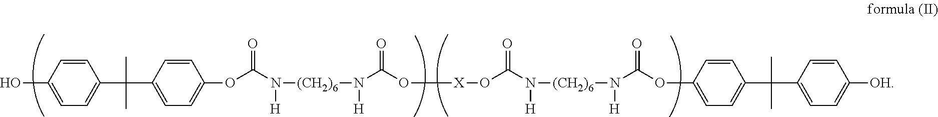

In formula (II), “X” is a structure formed by the polyester polyol after polymerization. The number average molecular weight of the self-healing resin can range from 30,000 g/mol to 200,000 g/mol. However, the present disclosure is not limited thereto.

In the self-healing resin composition, the hardener can be selected from the group consisting of: hexamethylene diisocyanate, 4,4′-diisocyanato dicyclohexylmethane, isophorone diisocyanate, and methylene diphenyl diisocyanate.

In the self-healing resin composition, the matting agent can be selected from the group consisting of: polymethylmethacrylate particles, polystyrene particles, and silica particles. A particle size (D₅₀, medium value of particle size distribution which means that 50% of the total particles being smaller than this size) of the matting agent can range from 0.5 μm to 10 μm.

Since specific monomers are chosen to polymerize the self-healing resin in the present disclosure, the self-healing ability of the self-healing resin will not be negatively affected by the addition of the matting agent.

In the self-healing resin composition, the solvent can be selected from the group consisting of: ethyl acetate, acetone, propylene glycol methyl ether acetate, dimethyl acetamide, methyl ethyl ketone, isopropyl alcohol, and ethanol. Preferably, the solvent is dimethyl acetamide. For considering the processing ability, a solid content of the self-healing resin composition can range from 35% to 45%.

In addition to the components mentioned above, the self-healing resin composition can further include a UV absorber, a leveling agent, a defoaming agent, a catalyst, or a combination thereof.

For example, the catalyst can be, but is not limited to, stannous octoate, dibutyltin dilaurate, dimethyl methyl phosphonate, or diethyl ethyl phosphonate. The addition of the catalysts is beneficial for polymerization and remediation of the self-healing resin. Based on the total weight of the self-healing resin composition being 100 phr, an amount of the catalysts can range from 1 phr to 5 phr.

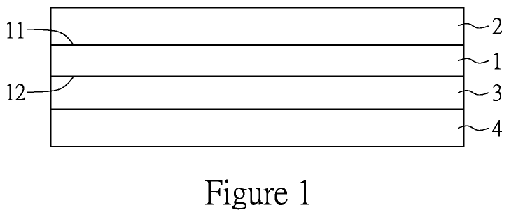

Referring to FIG. 1, the self-healing membrane structure includes a substrate layer 1, a self-healing membrane layer 2, an adhesive layer 3, and a release layer 4.

The substrate layer 1 has a first surface 11 and a second surface 12.

The self-healing resin composition mentioned above is coated onto the first surface 11 of the substrate layer 1. After a drying process and a ripening process, the self-healing membrane layer 2 is formed on the first surface 11. In other words, the self-healing membrane layer 2 is formed after solidification of the self-healing resin composition.

The adhesive layer 3 is disposed on the second surface 12 of the substrate layer 1.

The release layer 4 is disposed on the adhesive layer 3, and the adhesive layer 3 is disposed between the substrate layer 1 and the release layer 4. In addition, a peeling force of the release layer 4 relative to the adhesive layer 3 is low, such that the release layer 4 can be torn off before use. Through the adhesive layer 3, the substrate layer 1 and the self-healing membrane layer 2 can be attached onto the to-be-protected surface.

The self-healing membrane structure of the present disclosure has flexibility. After the release layer 4 is torn off, the self-healing membrane structure can be attached onto any surface via the adhesive layer 3 for protection purposes.

In order to illustrate the effect of the self-healing resin composition of the present disclosure, the polyester polyol is prepared by steps below, and the polyester polyol, the diisocyanate monomer, and the bisphenol monomer are polymerized to form the self-healing resin. However, the following examples are for illustrative purposes only, and the present disclosure is not limited thereto.

### Preparation of Polyester Polyol

50 g of 1,4-butanediol, 60 g of 1,6-hexanediol, 60 g of 2-methyl-1,3-butanediol, and 190 g of adipic acid are mixed and reacted at a temperature ranging from 150° C. to 200° C. for 1 hour to 2 hours, so as to obtain the polyester polyol. In this preparation, the number average molecular weight of the polyester polyol is 4,000 g/mol.

### Polymerization of Self-Healing Resin

According to equivalents (Eq) listed in Table 1 and Table 2, the polyester polyol and hexamethylene diisocyanate (HDI) (the diisocyanate monomer) are reacted at a temperature of 80° C. for 1 hour to 2 hours. Subsequently, bisphenol A (the bisphenol monomer) and dibutyltin dilaurate (catalyst) are further added into and reacted with the polyester polyol and HDI at a temperature of 100° C. for 5 hours to 6 hours. Finally, the self-healing resins of Examples 1 to 5 and Comparative Examples 1 to 4 can be obtained.

In order to evaluate the self-healing effect, 100 phr of the self-healing resin, 10 phr of the hardener, 0.5 phr of the matting agent, and 300 phr of the solvent are mixed to form the self-healing resin compositions of Examples 1 to 5 and Comparative Examples 1 to 4.

When the solid content of the self-healing resin composition is 40%, a viscosity of the self-healing resin composition can range from 500 cps to 10,000 cps. For example, the viscosity of the self-healing resin composition can be 1,000 cps, 2,000 cps, 3,000 cps, 4,000 cps, 5,000 cps, 6,000 cps, 7,000 cps, 8,000 cps, or 9,000 cps. However, the present disclosure is not limited thereto.

After preparation of the self-healing resin composition, the self-healing resin composition is coated onto the polyurethane substrate or the polyvinyl chloride substrate, is baked at a temperature ranging from 80° C. to 120° C. for 3 minutes to 5 minutes, and is ripened at a temperature ranging from 40° C. to 70° C. for 24 hours to 120 hours. In this way, the self-healing membrane layer having a thickness of from 5 um to 50 um is formed on the substrate layer, and samples can be obtained.

In the test of repair time, the samples are scratched by a copper brush. Then, the scratched samples are placed at a temperature of 100° C. During the process, the repair time of the scratched samples is measured to evaluate the self-healing ability, and the results are listed in Table 1 and Table 2.

TABLE 1

| | | Example | | | | |
|---|---|---|---|---|---|---|
| | | 1 | 2 | 3 | 4 | 5 |
| Self- | Polyester | 1 | 1 | 1 | 1 | 1 |
| healing | polyol (Eq) | | | | | |
| resin | Bisphenol | 1 | 1 | 1 | 1 | 1 |
| | monomer | | | | | |
| | (Eq) | | | | | |
| | Diisocyanate | 1.5 | 1.5 | 1 | 1.5 | 1.5 |
| | monomer | | | | | |
| | (Eq) | | | | | |
| | Functional | 1.33 | 1.33 | 2.0 | 1.33 | 1.33 |
| | group ratio | | | | | |
| | of OH/NCO | | | | | |
| | Number | 50,000 | 30,000 | 50,000 | 150,000 | 200,000 |
| | average | | | | | |
| | molecular | | | | | |
| | weight | | | | | |
| | (g/mol) | | | | | |
| Self- | Viscosity at | 6,000 | 500 | 5000 | 8,000 | 10,000 |
| healing | solid content | | | | | |
| resin | of 40% | | | | | |
| com- | (cps) | | | | | |
| position | | | | | | |
| Self- | Repair time | 10 | 20 | 30 | 10 | 40 |
| healing | (minutes) | | | | | |
| mem- | | | | | | |
| brane | | | | | | |
| layer | | | | | | |

TABLE 2

| | | Comparative Example | | | |
|---|---|---|---|---|---|
| | | 1 | 2 | 3 | 4 |
| Self-healing | Polyester | 1 | 1.5 | 1 | 1 |
| resin | polyol (Eq) | | | | |
| | Bisphenol | 1 | 1 | 2 | 1 |
| | monomer (Eq) | | | | |
| | Diisocyanate | 2 | 1 | 2 | 1.5 |
| | monomer (Eq) | | | | |
| | Functional | 1.0 | 2.5 | 1.5 | 1.33 |
| | group ratio of | | | | |
| | OH/NCO | | | | |
| | Number | 50,000 | 30,000 | 20,000 | 2,500,000 |
| | average | | | | |
| | molecular | | | | |
| | weight | | | | 0 |
| | (g/mol) | | | | |
| Self-healing | Viscosity at | 2,500 | 500 | 500 | 17,000 |
| resin | solid content | | | | |
| composition | of 40% (cps) | | | | |

| | | |
|---|---|---|
| Self-healing | Repair time | Not |
| membrane | (minutes) | repairable |
| layer | | |

According to Table 1 and Table 2, the self-healing resin composition of the present disclosure can form into the self-healing membrane layer that has the self-healing ability. By being heated at a temperature ranging from 80° C. to 130° C., scratches formed on the self-healing membrane layer can be repaired due to intermolecular force.

According to Table 1 and Table 2, a functional group ratio in the monomers to polymerize the self-healing resin may affect the self-healing effect of the self-healing resin composition. According to Example 1 and Comparative Example 1, when the molar ratio of the hydroxyl group to the isocyanate group in the monomers to polymerize the self-healing resin (i.e., a functional group ratio of OH/NCO) is lower than 1.33, the self-healing membrane layer does not have the self-healing ability. According to Example 2 and Comparative Example 2, when the molar ratio of the hydroxyl group to the isocyanate group in the monomers to polymerize the self-healing resin (i.e., a functional group ratio of OH/NCO) is higher than 2.5, the self-healing membrane layer does not have the self-healing ability. Therefore, the molar ratio of the hydroxyl group to the isocyanate group in the monomers to polymerize the self-healing resin is required to range from 1.33 to 2.0, and preferably ranges from 1.33 to 1.66.

According to Table 1 and Table 2, the number average molecular weight of the self-healing resin may also affect the self-healing effect of the self-healing resin composition. According to Comparative Example 3, when the number average molecular weight of the self-healing resin is lower than 30,000 g/mol, the self-healing membrane layer does not have the self-healing ability. According to Example 5 and Comparative Example 4, when the number average molecular weight of the self-healing resin is higher than 200,000 g/mol, the self-healing membrane layer does not have the self-healing ability. Therefore, the number average molecular weight of the self-healing resin is required to range from 30,000 g/mol to 200,000 g/mol, and preferably ranges from 50,000 g/mol to 150,000 g/mol.

### Beneficial Effects of the Embodiments

In conclusion, in the self-healing resin composition and the self-healing membrane structure provided by the present disclosure, by virtue of “the self-healing resin being polymerized from a polyester polyol, a diisocyanate monomer, and a bisphenol monomer,” “a molar ratio of a hydroxyl group to an isocyanate group in monomers to polymerize the self-healing resin ranging from 1.33 to 2.0,” and “a number average molecular weight of the self-healing resin ranging from 30,000 g/mol to 200,000 g/mol,” the self-healing membrane layer formed from the self-healing resin composition has the self-healing ability when being temporarily heated or at a room temperature.

Furthermore, in order to enhance the self-healing ability of the self-healing resin composition, the variety and the content of the monomers to polymerize the self-healing resin are controlled in the present disclosure. By choosing the specific polyester polyol, the specific diisocyanate monomer, and the specific bisphenol monomer, the self-healing ability of the self-healing membrane layer can be enhanced. In addition, the variety and the content of the monomers to polymerize the polyester polyol and the molecular weight of the polyester polyol are also controlled to adjust the properties of the polyester polyol.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A self-healing resin composition, comprising:
20 phr to 50 phr of a self-healing resin, wherein the self-healing resin is polymerized from a polyester polyol, a diisocyanate monomer, and a bisphenol monomer; wherein a molar ratio of a hydroxyl group to an isocyanate group in monomers to polymerize the self-healing resin ranges from 1.33 to 2.0, and a number average molecular weight of the self-healing resin ranges from 30,000 g/mol to 200,000 g/mol;
1 phr to 10 phr of a hardener;
0.1 phr to 3 phr of a matting agent; and
40 phr to 80 phr of a solvent.

2. The self-healing resin composition according to claim 1, wherein, based on a total weight of the monomers to polymerize the self-healing resin being 100 wt %, an amount of the polyester polyol ranges from 75 wt % 90 wt %, an amount of the diisocyanate monomer ranges from 3 wt % 10 wt %, and an amount of the bisphenol monomer ranges from 5 wt % 15 wt %.

3. The self-healing resin composition according to claim 1, wherein a number average molecular weight of the polyester polyol ranges from 3,000 g/mol to 5,000 g/mol.

4. The self-healing resin composition according to claim 1, wherein the polyester polyol is polymerized from adipic acid, 1,4-butanediol, 1,6-hexanediol, and 2-methyl-1,3-propanediol.

5. The self-healing resin composition according to claim 4, wherein a molar ratio of 1,4-butanediol to 1,6-hexanediol ranges from 1:0.5 to 1:2, and a molar ratio of 1,4-butanediol to 2-methyl-1,3-propanediol ranges from 1:0.33 to 1:3.

6. The self-healing resin composition according to claim 1, wherein the diisocyanate monomer is selected from the group consisting of: hexamethylene diisocyanate, 4,4′-diisocyanato dicyclohexylmethane, isophorone diisocyanate, methylene diphenyl diisocyanate, and hexamethylene diisocyanate trimer.

7. The self-healing resin composition according to claim 1, wherein the bisphenol monomer is selected from the group consisting of: bisphenol A, bis(4-hydroxyphenyl)cyclohexane, 1,1′-bis(4-hydroxyphenyl)-3,3,5-trimethylcyclohexane, bisphenoxyethanolfluorene, and dimethyl-bisphenol A.

8. A self-healing membrane structure, comprising;
a substrate layer having a first surface and a second surface;
a self-healing membrane layer disposed on the first surface, wherein the self-healing membrane layer is formed from the self-healing resin composition as claimed in claim 1;
an adhesive layer disposed on the second surface; and
a release layer, wherein the release layer is disposed on the adhesive layer, such that the adhesive layer is disposed between the substrate layer and the release layer.

9. The self-healing membrane structure according to claim 8, wherein the substrate layer is a polyurethane substrate or a polyvinyl chloride substrate.

10. The self-healing membrane structure according to claim 8, wherein a thickness of the self-healing membrane layer ranges from 5 μm to 50 μm.
